(19) United States
(12) Patent Application Publication
(10) Pub. No.: US 2024/0421668 A1
(43) Pub. Date: Dec. 19, 2024

(54) CRYOCOOLER

(71) Applicant: SUMITOMO HEAVY INDUSTRIES, LTD., Tokyo (JP)

(72) Inventor: Jyun YOSHIDA, Yokosuka-shi (JP)

(73) Assignee: SUMITOMO HEAVY INDUSTRIES, LTD., Tokyo (JP)

(21) Appl. No.: 18/740,399

(22) Filed: Jun. 11, 2024

(30) Foreign Application Priority Data
Jun. 14, 2023 (JP) 2023-097479

(51) Int. Cl. H02K 11/01; F25B 9/14; F25B 41/35

(52) U.S. Cl. CPC H02K 11/01; F25B 9/14; F25B 41/35

(57) ABSTRACT

A cryocooler includes an expander motor, a speed reducer connected to the expander motor, and a magnetic shield that surrounds the speed reducer.

### CROSS-REFERENCE TO RELATED APPLICATIONS

This application claims priority to Japanese Patent Application No. 2023-097479, filed on Jun. 14, 2023, which is incorporated by reference herein in its entirety.

### BACKGROUND

### Technical Field

A certain embodiment of the present invention relates to a cryocooler.

### Description of Related Art

In the related art, in an expander of a Gifford-McMahon (GM) cryocooler, a configuration in which a drive motor is connected to a pressure control valve via a speed reducer is known. One of the main applications of such a cryocooler is cooling a superconducting magnet. A strong static magnetic field generated by the superconducting magnet is used, for example, for magnetic resonance imaging (MRI).

### SUMMARY

According to an aspect of the present invention, a cryocooler includes: an electromagnetic motor; a speed reducer connected to the electromagnetic motor; and a magnetic shield that surrounds the speed reducer.

According to the present invention, magnetic noise generated from a cryocooler can be reduced.

### BRIEF DESCRIPTION OF THE DRAWINGS

FIG. 1 is a diagram schematically showing a cryocooler according to an embodiment.

FIG. 2 is a view schematically showing the cryocooler according to the embodiment.

FIG. 3 is a diagram schematically showing the cryocooler according to the embodiment.

FIG. 4 is a view schematically illustrating an exploded perspective view of a main part of a motion conversion mechanism of a cold head according to the embodiment.

FIGS. 5A to 5F are views schematically showing a design example of a key combination.

FIGS. 6A to 6F are views schematically showing a design example of a key combination.

FIG. 7 is a view schematically showing a design example of a key combination.

FIG. 8 is a graph showing magnetic noise analysis results for key combination design examples shown in FIGS. 5A to 5F, FIGS. 6A to 6F, and FIG. 7.

FIG. 9 is a graph showing dimensional dependence of magnetic noise according to the embodiment.

FIG. 10 is a graph showing dimensional dependence of magnetic noise according to the embodiment.

### DETAILED DESCRIPTION

The present inventors have studied the cryocooler described above and have recognized the followings. For rotating parts of a speed reducer such as gears and shafts, steel materials subjected to a surface hardening process such as carburizing and nitriding are likely to be used in order to secure sufficient strength. Since such a steel material is a magnetic material, magnetic noise can be generated when rotating in a high magnetic field environment. The magnetic noise can adversely affect imaging by MRI.

It is desirable to reduce magnetic noise generated from a cryocooler.

Hereinafter, an embodiment for carrying out the present invention will be described in detail with reference to the drawings. In the description and drawings, identical or equivalent components, members, and processing are denoted by the same reference numerals, and overlapping description is omitted as appropriate. The scale or shape of each part that is shown in the drawings is conveniently set for ease of description and is not limitedly interpreted unless otherwise specified. The embodiments are exemplary and do not limit the scope of the present invention. All features or combinations thereof described in the embodiments are not necessarily essential to the invention.

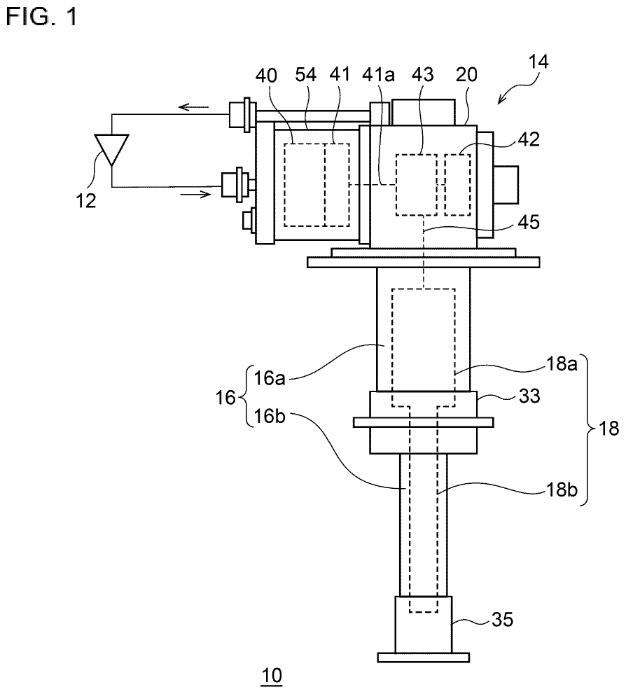

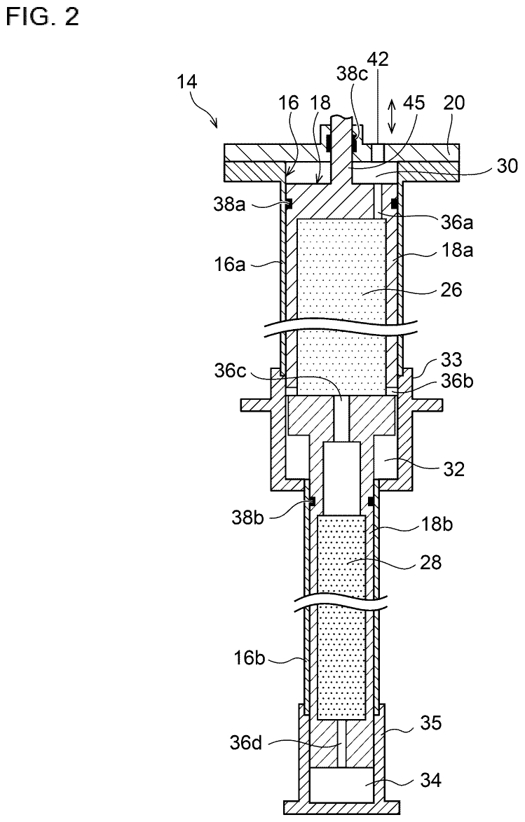

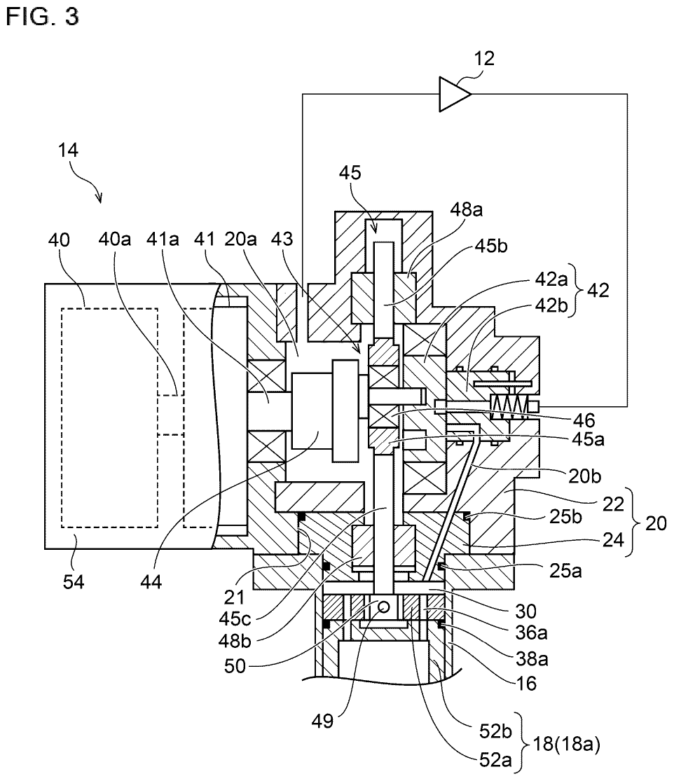

FIGS. 1 to 3 are diagrams schematically showing a cryocooler 10 according to an embodiment. FIG. 1 shows an appearance of a cold head of the cryocooler 10, and FIG. 2 shows an internal structure of a low-temperature section of the cold head. FIG. 3 shows an internal structure of a drive unit of the cold head. The cryocooler 10 is usually installed in a vacuum chamber (not illustrated) such that a low-temperature section is disposed inside the vacuum chamber and a drive unit is disposed in an ambient environment (for example, a room temperature atmospheric pressure environment) outside the vacuum chamber. The cryocooler 10 is, for example, a two-stage type Gifford-McMahon (GM) cryocooler.

The cryocooler 10 includes a compressor 12 and an expander 14. The compressor 12 is configured to collect a working gas of the cryocooler 10 from the expander 14, to pressurize the collected working gas, and to supply the working gas to the expander 14 again. A refrigeration cycle of the cryocooler 10 is configured by the compressor 12 and the expander 14, whereby the cryocooler 10 can provide desired cryogenic cooling. The expander 14 is also often referred to as a cold head. The working gas is also called a refrigerant gas, and other suitable gases may be used although a helium gas is typically used. To facilitate understanding, a direction in which the working gas flows is shown with arrows in FIG. 1.

In general, both of the pressure of a working gas supplied from the compressor 12 to the expander 14 and the pressure of a working gas recovered from the expander 14 to the compressor 12 are considerably higher than the atmospheric pressure, and can also be called a first high pressure and a second high pressure, respectively. For convenience of description, the first high pressure and the second high pressure are simply called a high pressure and a low pressure, respectively. Typically, the high pressure is, for example, 2 to 3 MPa. The low pressure is, for example, 0.5 to 1.5 MPa, and is, for example, about 0.8 MPa. For better understanding, a direction in which the working gas flows is shown with arrows.

The expander 14 includes a cryocooler cylinder 16, a displacer assembly (hereinafter, may be simply referred to as a displacer) 18, and a cryocooler housing (hereinafter, may be simply referred to as a housing) 20. The cryocooler cylinder 16 guides the linear reciprocation of the displacer 18, and forms expansion chambers (32, 34) as expansion spaces for the working gas between the displacer 18 and the cryocooler cylinder 16. The cryocooler cylinder 16 is fixed to the cryocooler housing 20, thereby forming a casing of the expander 14, and forming an airtight space for accommodating the displacer 18 in the cryocooler cylinder 16.

In the present specification, in order to describe a positional relationship between components of the cryocooler 10, for convenience of description, a side close to a top dead center of axial reciprocation of a displacer will be referred to as “up” and a side close to a bottom dead center will be referred to as “down”. The top dead center is the position of the displacer at which the volume of an expansion space is maximum, and the bottom dead center is the position of the displacer at which the volume of the expansion space is minimum. Since a temperature gradient in which the temperature drops from an upper side to a lower side in an axial direction is generated during the operation of the cryocooler 10, the upper side can also be called a high temperature side and the lower side can also be called a low temperature side.

The cryocooler cylinder 16 includes a first cylinder 16a and a second cylinder 16b. The first cylinder 16a and the second cylinder 16b each are, for example, a member that has a cylindrical shape, and the second cylinder 16b has a diameter smaller than that of the first cylinder 16a. The first cylinder 16a and the second cylinder 16b are coaxially disposed, and a lower end of the first cylinder 16a is strongly connected to an upper end of the second cylinder 16b.

The displacer assembly 18 includes a first displacer 18a and a second displacer 18b that are connected to each other, and the displacers move integrally. The first displacer 18a and the second displacer 18b each are, for example, a member that has a cylindrical shape, and the second displacer 18b has a diameter smaller than that of the first displacer 18a. The first displacer 18a and the second displacer 18b are coaxially disposed.

The first displacer 18a is accommodated in the first cylinder 16a, and the second displacer 18b is accommodated in the second cylinder 16b. The first displacer 18a can reciprocate in the axial direction along the first cylinder 16a, and the second displacer 18b can reciprocate in the axial direction along the second cylinder 16b.

As shown in FIG. 2, the first displacer 18a accommodates a first regenerator 26. The first regenerator 26 is formed by filling a tubular main body portion of the first displacer 18a with, for example, a wire mesh made of, such as copper, or other appropriate first regenerator material. An upper lid portion and a lower lid portion of the first displacer 18a may be provided as members separate from the main body portion of the first displacer 18a, or the first regenerator material may be accommodated in the first displacer 18a by fixing the upper lid portion and the lower lid portion of the first displacer 18a to the main body through appropriate means such as fastening and welding.

Similarly, the second displacer 18b accommodates a second regenerator 28. The second regenerator 28 is formed by filling a tubular main body portion of the second displacer 18b with, for example, a non-magnetic regenerator material such as bismuth, a magnetic regenerator material such as HoCu₂, or other appropriate second regenerator material. The second regenerator material may be molded into a granular shape. An upper lid portion and a lower lid portion of the second displacer 18b may be provided as members separate from the main body of the second displacer 18b, or the second regenerator material may be accommodated in the second displacer 18b by fixing the lower lid portion and the upper lid portion of the second displacer 18b to the main body through appropriate means such as fastening and welding.

The displacer 18 forms, inside the cryocooler cylinder 16, an upper chamber 30, a first expansion chamber 32, and a second expansion chamber 34. In order to exchange heat with a desired object or medium to be cooled by the cryocooler 10, the expander 14 includes a first cooling stage 33 and a second cooling stage 35. The upper chamber 30 is formed between the upper lid portion of the first displacer 18a and an upper portion of the first cylinder 16a. The first expansion chamber 32 is formed between the lower lid portion of the first displacer 18a and the first cooling stage 33. The second expansion chamber 34 is formed between the lower lid portion of the second displacer 18b and the second cooling stage 35. The first cooling stage 33 is fixed to a lower portion of the first cylinder 16a to surround the first expansion chamber 32, and the second cooling stage 35 is fixed to a lower portion of the second cylinder 16b to surround the second expansion chamber 34.

The first regenerator 26 is connected to the upper chamber 30 through a working gas flow path 36a formed in the upper lid portion of the first displacer 18a, and is connected to the first expansion chamber 32 through a working gas flow path 36b formed in the lower lid portion of the first displacer 18a. The second regenerator 28 is connected to the first regenerator 26 through a working gas flow path 36c formed from the lower lid portion of the first displacer 18a to the upper lid portion of the second displacer 18b. In addition, the second regenerator 28 is connected to the second expansion chamber 34 through a working gas flow path 36d formed in the lower lid portion of the second displacer 18b.

In order to introduce working gas flow between the first expansion chamber 32, the second expansion chamber 34, and the upper chamber 30 to the first regenerator 26 and the second regenerator 28 instead of a clearance between the cryocooler cylinder 16 and the displacer 18, a first seal 38a and a second seal 38b may be provided. The first seal 38a may be mounted on the upper lid portion of the first displacer 18a to be disposed between the first displacer 18a and the first cylinder 16a. The second seal 38b may be mounted on the upper lid portion of the second displacer 18b to be disposed between the second displacer 18b and the second cylinder 16b.

As shown in FIG. 3, the cryocooler housing 20 includes a housing main body 22 having a lower opening 21 and a lower cover 24 that closes the lower opening 21. The lower opening 21 is formed on a lower surface of the housing main body 22. As illustrated, the housing internal volume 20a formed by the housing main body 22 and the lower cover 24 may be connected to a low pressure side of the compressor 12 and maintained at a low pressure. The cryocooler housing 20 is formed of a non-magnetic material such as stainless steel or an aluminum alloy.

The lower cover 24 partitions the housing internal volume 20a and the displacer accommodating space (upper chamber 30) in the cryocooler cylinder 16. The lower cover 24 has a disk-like shape as a whole, and more specifically, has a large-diameter portion on the upper side and a small-diameter portion on the lower side. A first sealing member 25a is provided between the lower cover 24 and the cryocooler cylinder 16 in order to maintain the airtightness of the internal volume of the cryocooler cylinder 16, and a second sealing member 25b is provided between the lower cover 24 and the housing main body 22 in order to maintain the airtightness of the housing internal volume 20a. As illustrated, the first sealing member 25a may be mounted on the small-diameter portion of the lower cover 24, and the second sealing member 25b may be mounted on the large-diameter portion of the lower cover 24.

The lower cover 24 is detachably fitted into the lower opening 21, and the upper flange portion of the cryocooler cylinder 16 is fastened to the housing main body 22 by a fastening member such as a bolt. In this way, the lower cover 24 is sandwiched between the housing main body 22 and the upper flange portion of the cryocooler cylinder 16. The lower cover 24 is not fixed to the housing main body 22 by fastening. However, a structure in which the housing main body 22 and the lower cover 24 are fastened with a fastening member such as a bolt may be adopted.

Further, the expander 14 includes an expander motor 40, a speed reducer 41, a rotary valve 42, and a motion conversion mechanism 43. The expander motor 40 and the speed reducer 41 are housed in a magnetic shield 54 (described later) instead of the cryocooler housing 20. The rotary valve 42 and the motion conversion mechanism 43 are disposed outside the magnetic shield 54 and are accommodated in the cryocooler housing 20.

The expander motor 40 is provided in the expander 14 as a drive source for the displacer 18 and the rotary valve 42. The expander motor 40 may be an appropriate electromagnetic motor, may be configured to rotate the motor rotary shaft 40a at a constant rotation speed, or may be capable of variably controlling the rotation speed of the motor rotary shaft 40a.

The speed reducer 41 connects the expander motor 40 to the rotary valve 42 and the motion conversion mechanism 43. The motor rotary shaft 40a of the expander motor 40 is connected to an input shaft of the speed reducer 41, and the rotation of the motor rotary shaft 40a is decelerated by the speed reducer 41 at a predetermined reduction ratio and is output from the output shaft 41a of the speed reducer 41. As the speed reducer 41, for example, any speed reduction mechanism such as a bending meshing type speed reducer, an eccentric oscillation type speed reducer, a simple planetary gear device, an orthogonal shaft gear device, or a parallel shaft gear device can be appropriately adopted. Further, the speed reducer 41 is not limited to those that perform deceleration by means of gears, and may be, for example, a traction drive. By incorporating the speed reducer 41 into the drive unit of the cryocooler 10, the expander motor 40 can be downsized.

In the rotary valve 42, the high pressure side and the low pressure side of the compressor 12 are alternately connected to the cryocooler cylinder 16 (that is, the upper chamber 30, the first expansion chamber 32, and the second expansion chamber 34), and the rotary valve 42 is configured to periodically switch between intake and exhaust of the cryocooler cylinder 16.

The rotary valve 42 includes a valve rotor 42a and a valve stator 42b, and the valve rotor 42a is in contact with the valve stator 42b to rotate while sliding with respect to the valve stator 42b. The valve rotor 42a is rotatably supported with respect to the housing main body 22, and the valve stator 42b is non-rotatably supported with respect to the housing main body 22. An elastic body such as a spring for pressing the valve stator 42b toward the valve rotor 42a in the direction of the rotary shaft of the valve rotor 42a may be interposed between the valve stator 42b and the housing main body 22.

A housing internal flow path 20b for connecting the rotary valve 42 to the upper chamber 30 is formed in the cryocooler housing 20, and a valve internal flow path for alternately connecting the housing internal flow path 20b to the high pressure side of the compressor 12 and the housing internal volume 20a is formed in the valve rotor 42a and the valve stator 42b of the rotary valve 42. Various known forms can be adopted for the valve internal flow path, which will not be described in detail here.

The motion conversion mechanism 43 is configured to connect the expander motor 40 to the rotary valve 42 and the displacer 18 to transmit the rotation of the output shaft 41a of the speed reducer 41 to the rotary valve 42 and convert the rotation into a linear reciprocation of the displacer 18. An example of the motion conversion mechanism 43 will be described later. One rotation of the output shaft 41a causes one reciprocation of the displacer 18 via the motion conversion mechanism 43, whereby the volume of the expansion space of the working gas is periodically changed. At the same time, one rotation of the output shaft 41a causes one rotation of the rotary valve 42 via the motion conversion mechanism 43, whereby the pressure in the expansion space of the working gas is periodically changed.

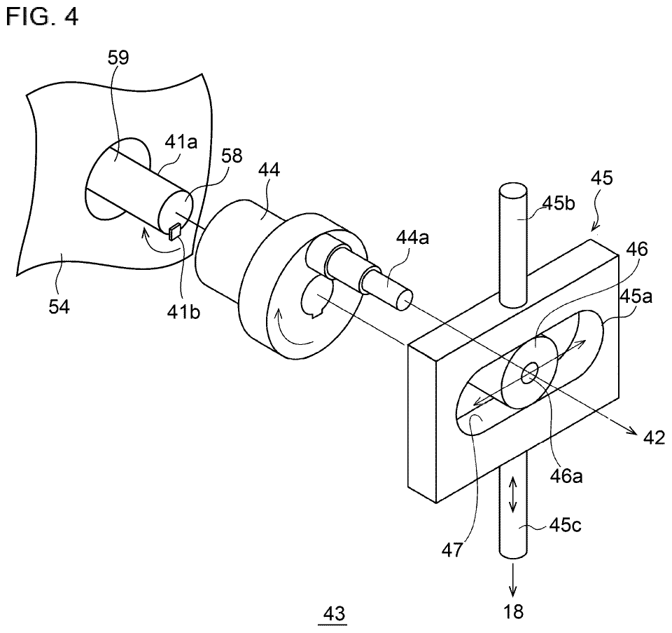

FIG. 4 is a view schematically illustrating an exploded perspective view of a main part of a motion conversion mechanism 43 of a cold head according to the embodiment. The motion conversion mechanism 43 is a scotch yoke in this embodiment, and includes a crank 44 having a crank pin 44a, a scotch yoke shaft 45, and a crank pin bearing 46. The scotch yoke shaft 45 includes a scotch yoke plate 45a, an upper rod 45b, and a lower rod 45c. The scotch yoke shaft 45 may be formed of a metal material such as stainless steel, for example.

The crank 44 is fixed to the output shaft 41a of the speed reducer 41. The output shaft 41a is connected to the crank 44 by a key 41b through a key combination. The shape of the key 41b is not limited to a specific shape. The key 41b may have an appropriate key shape such as, for example, a parallel key, a half-moon key, a sliding key, or a D-cut. In addition, the crank pin 44a extends parallel to the output shaft 41a at a position eccentric from the output shaft 41a. The crank pin 44a extends from the crank 44 toward the side opposite to the output shaft 41a with respect to the crank 44.

The scotch yoke plate 45a is a rectangular plate-shaped member having a horizontally long window 47. The horizontally long window 47 extends in a direction perpendicular to the axial direction and the output shaft 41a of the speed reducer 41. The crank pin bearing 46 is disposed to be rollable in the horizontally long window 47. The crank pin bearing 46 may be, for example, a roller bearing. An engagement hole 46a that engages with the crank pin 44a is formed in the center of the crank pin bearing 46, and the crank pin 44a penetrates the engagement hole 46a.

On the side opposite to the crank 44 with respect to the scotch yoke plate 45a, a valve rotor 42a of a rotary valve 42 is disposed with its center axis aligned with the output shaft 41a, and the tip of a crank pin 44a passing through an engagement hole 46a is fixed to the valve rotor 42a.

The upper rod 45b extends upward from the center of the upper frame of the scotch yoke plate 45a, the lower rod 45c extends downward from the center of the lower frame of the scotch yoke plate 45a, and these rods are coaxially disposed. The scotch yoke plate 45a and the upper rod 45b are accommodated in the cryocooler housing 20, and the lower rod 45c penetrates the lower cover 24 and extends outside the cryocooler housing 20. The tip of the lower rod 45c is connected to the displacer 18 in the cryocooler cylinder 16.

A first sliding bearing 48a is provided between the upper rod 45b and the housing main body 22, and a second sliding bearing 48b is provided between the lower rod 45c and the lower cover 24. The housing main body 22 has a recessed portion in an upper portion thereof that receives the upper rod 45b, and the first sliding bearing 48a is disposed in the recessed portion to support the upper rod 45b to be slidable in the axial direction. The lower cover 24 has a through-hole in a central portion thereof, and the second sliding bearing 48b is disposed in the through-hole to support the lower rod 45c to be slidable in the axial direction. The second sliding bearing 48b is provided with a sealing portion such as a slipper seal or a clearance seal, and is configured to be airtight. Therefore, the housing internal volume 20a is isolated from the upper chamber 30. There is no direct gas flow between the housing internal volume 20a and the upper chamber 30.

A collar portion 50 is fixed to the tip of the lower rod 45c connected to the displacer 18 by a fixing pin 49. The collar portion 50 is a short tubular member connected to the tip of the displacer assembly 18. A through-hole is formed in the tip of the lower rod 45c and the collar portion 50 in a direction perpendicular to the axial direction, and the collar portion 50 is fixed to the lower rod 45c by fitting the fixing pin 49 into the through-hole.

The first displacer 18a has a lid portion 52a and a main body portion 52b. The lid portion 52a is an upper lid of the first displacer 18a, and has a disk-like shape. The lid portion 52a is formed of a metal material or other material, for example, an alumite-treated aluminum alloy. The main body portion 52b has a cylindrical shape, and has a regenerator inside the main body portion 52b. The main body portion 52b is formed of a synthetic resin material or other materials, and may be formed of, for example, a phenol resin such as Bakelite. The working gas flow path 36a described above is formed by penetrating the lid portion 52a and the upper end portion of the main body portion 52b in the axial direction. The first seal 38a described above may be sandwiched between the outermost peripheral portions of the lid portion 52a and the main body portion 52b. The lid portion 52a and the main body portion 52b are fixed to each other by using a fastening member such as a bolt or by another method such as bonding.

A through-hole for receiving the tip of the lower rod 45c and the collar portion 50 is formed in a central portion of the lid portion 52a. The collar portion 50 has a flange portion extending outward in the radial direction at a lower end portion thereof, and the flange portion is sandwiched between the lid portion 52a and the main body portion 52b of the first displacer 18a so that the lower rod 45c and the collar portion 50 are connected to the first displacer 18a. In this way, the displacer 18 is attached to the scotch yoke shaft 45.

Therefore, when the expander motor 40 is driven and the motor rotary shaft 40a rotates, the output shaft 41a rotates via the speed reducer 41. The rotation of the expander motor 40 is decelerated by the speed reducer 41 and transmitted to the rotary valve 42 and the motion conversion mechanism 43. That is, the output torque of the expander motor 40 is amplified by the speed reducer 41, and the rotary valve 42 and the motion conversion mechanism 43 are driven by the amplified torque. Due to the rotation of the output shaft 41a of the speed reducer 41, the crank pin bearing 46 engaged with the crank pin 44a rotates in a circular motion. At this time, the crank pin bearing 46 reciprocates in the horizontally long window 47 of the scotch yoke plate 45a, and the scotch yoke shaft 45 and the displacer 18 reciprocate in the axial direction. In this way, the expander motor 40 drives the axial reciprocation of the displacer 18, and rotates the rotary valve 42 in synchronization with the axial reciprocation.

In this way, synchronized volume and pressure fluctuations are brought into the expansion space to configure a refrigeration cycle of the cryocooler 10, whereby the cryocooler 10 can provide desired cryogenic cooling. The first cooling stage 33 can be cooled to the first cooling temperature, and the second cooling stage 35 can be cooled to a second cooling temperature lower than the first cooling temperature. The first cooling temperature may be, for example, in a range of about 10K to about 100K, or in a range of about 20K to about 40K. The second cooling temperature may be, for example, about 20K or less, about 10K or less, or in the range of about 1K to about 4K.

Further, the expander 14 includes the magnetic shield 54. The magnetic shield 54 is formed of, for example, a magnetic material such as iron material. The magnetic shield 54 is a case that surrounds the expander motor 40 and the speed reducer 41, and the entire expander motor 40 and most of the speed reducer 41 (that is, the rest of the speed reducer 41 excluding the output shaft 41a) are accommodated in the magnetic shield 54. The magnetic shield 54 is airtightly connected to the cryocooler housing 20 to maintain the airtightness of the housing internal volume 20a. The magnetic shield 54 is attached to a side surface of the housing main body 22.

An example of a cooling target of the cryocooler 10 according to the embodiment is a superconducting magnet. The superconducting magnet is generally used to generate a strong magnetic field. For this reason, when the cryocooler 10 is used for cooling the superconducting magnet, the cryocooler 10 and the drive unit are also exposed to a magnetic field generated by the superconducting magnet.

However, the cryocooler 10 is provided with the magnetic shield 54. The magnetic shield 54 can shield the strong magnetic field of the superconducting magnet. Since the expander motor 40 is disposed inside the magnetic shield 54, the expander motor 40 is not exposed to a strong magnetic field of the superconducting magnet. It is possible to prevent an adverse effect on the expander motor 40 (for example, a reduction in the rated torque) due to the strong magnetic field, and to prevent a decrease in the cooling capacity of the cryocooler 10.

For rotating parts of a speed reducer 41 such as gears and shafts, steel materials subjected to a surface hardening process such as carburizing and nitriding are likely to be used in order to secure sufficient strength. Since such a steel material is a magnetic material, magnetic noise (a fluctuation component of a magnetic field having a frequency of rotation) can be generated when rotating in a high magnetic field environment. A strong static magnetic field generated by the superconducting magnet can be utilized, for example, for magnetic resonance imaging (MRI). In a case where the magnetic noise generated by the speed reducer 41 is widely propagated to the surroundings, the magnetic noise may adversely affect the imaging by the MRI.

However, not only the expander motor 40 but also the speed reducer 41 is covered with the magnetic shield 54. Therefore, the magnetic noise that can be generated by the speed reducer 41 can be shielded by the magnetic shield 54, and the propagation of the magnetic noise to the outside of the magnetic shield 54 can be prevented or reduced.

In this embodiment, the cryocooler 10 includes a mating part (for example, a motion conversion mechanism 43) disposed outside the magnetic shield 54. The output shaft 41a of the speed reducer 41 extends out of the magnetic shield 54 and is formed of a magnetic material (iron material, for example, carbon steel such as SS400). The output shaft 41a is connected to a mating part through the key combination. In this example, as shown in FIG. 4, the output shaft 41a is connected to the crank 44 by a key 41b through the key combination.

Since the output shaft 41a is not covered with the magnetic shield 54, the magnetic noise that can be generated due to the rotation thereof can propagate to the surroundings. In particular, since the rotational symmetry of the shape of the output shaft 41a is broken by the key structure, there is a concern that appropriate magnetic noise based on this shape is generated and propagated. As one countermeasure, similarly to the expander motor 40 and the speed reducer 41, it is conceivable that the output shaft 41a of the speed reducer 41 and the mating part connected to the output shaft 41a are surrounded by the magnetic shield 54. However, this causes an increase in the size of the magnetic shield 54, and further, there may be a demerit that an undesired strong electromagnetic force may act on the increased size magnetic shield under a strong magnetic field of the superconducting magnet.

In the existing design, the key 41b is also typically formed of a magnetic material, similarly to the output shaft 41a. According to the study of the present inventor, when the output shaft 41a and the key 41b rotate in a strong magnetic field environment, a relatively large magnetic saturation region may be generated at the tip of the key 41b. As the output shaft 41a and the key 41b rotate, the magnetic saturation region also rotates, which causes magnetic noise. Therefore, it is considered that reducing the magnetic saturation region at the tip of the key 41b leads to the reduction of magnetic noise. In this document, based on such considerations, some solutions for reducing magnetic noise are proposed below.

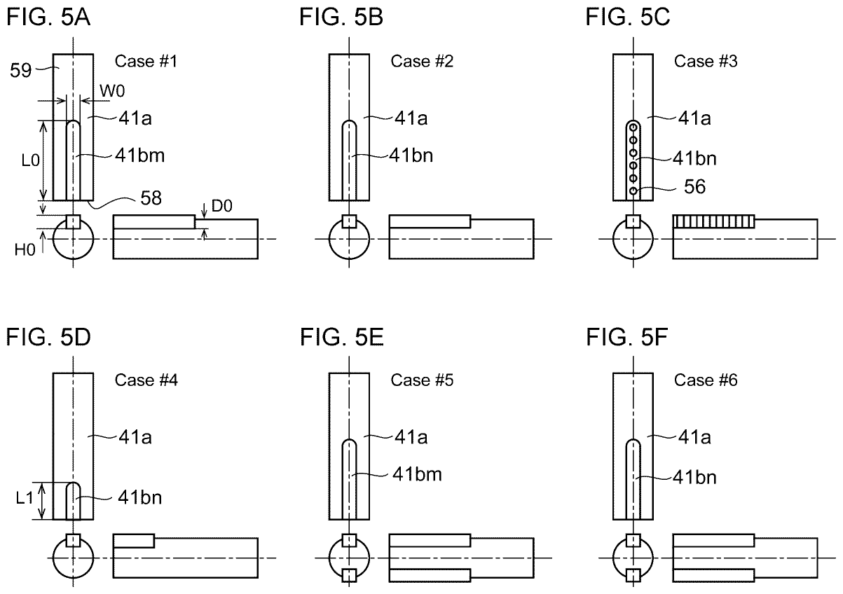

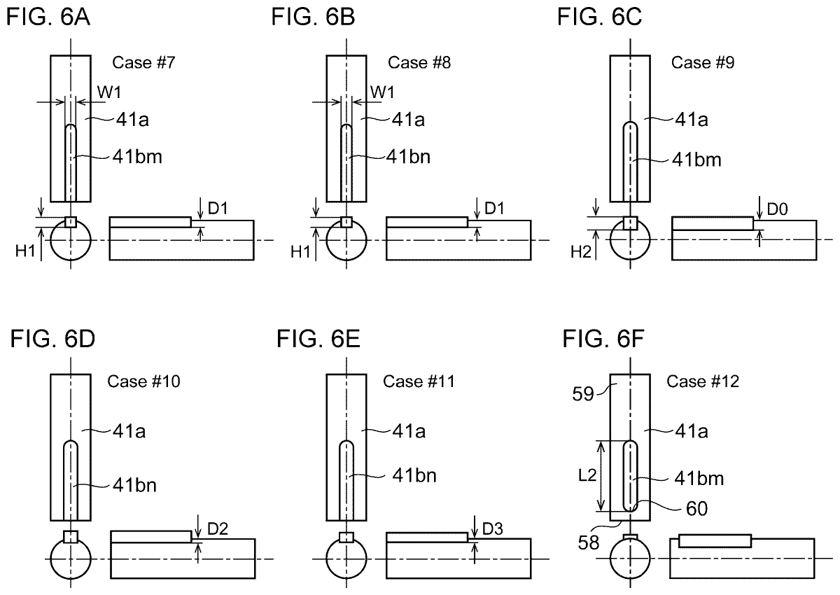

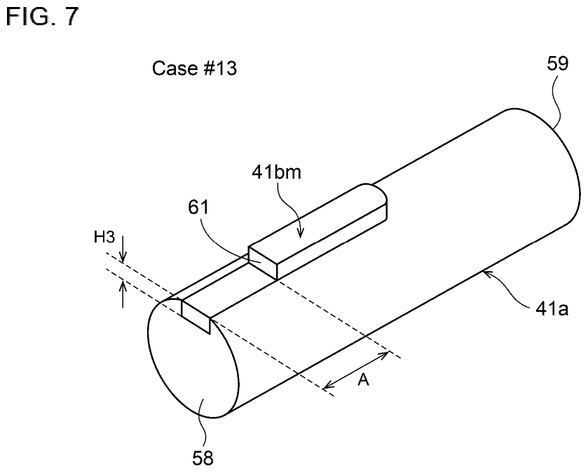

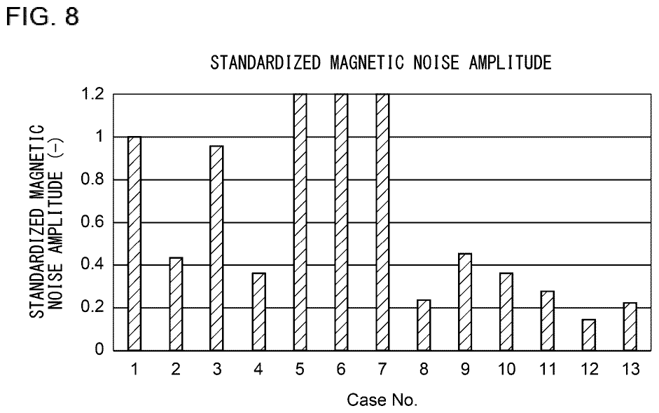

FIGS. 5A to 5F, FIGS. 6A to 6F, and FIG. 7 are views schematically showing a design example of a key combination. FIGS. 5A to 5F and FIGS. 6A to 6F show top views of the output shaft 41a and the key 41b, front views (showing the tip of the output shaft 41a), and cross-sectional views (a vertical sectional view including a center axis of the output shaft 41a). FIG. 7 shows a perspective view of the output shaft 41a and the key 41b. FIG. 8 is a graph showing magnetic noise analysis results for key combination design examples shown in FIGS. 5A to 5F, FIGS. 6A to 6F, and FIG. 7.

Case 1 shown in FIG. 5A shows a typical example of the key combination in an existing design as a comparative example. One key 41b is fitted into a key groove formed on the output shaft 41a. The output shaft 41a has a diameter of, for example, 10 mm or more and 30 mm or less. The key 41b has a reference length L0 (for example, 25 mm), a reference width W0 (for example, 4 mm), and a reference height H0 (for example, 4 mm). The output shaft 41a is formed of a magnetic material as described above. Similar to the output shaft 41a, the key 41b is formed of a magnetic material (described as a magnetic key 41bm in FIG. 5A). The key groove is formed on a side surface of the output shaft 41a from the tip 58 of the output shaft 41a toward the base portion 59 (that is, toward the magnetic shield 54 as shown in FIG. 4). The key groove has a reference depth DO (for example, 2.5 mm).

Case 2 shown in FIG. 5B is different from Case 1 in that the key 41b is formed of a non-magnetic material (described as a non-magnetic key 41bn in FIG. 5B). The non-magnetic material forming the key 41b is, for example, stainless steel (for example, austenite-based stainless steel such as SUS304). Alternatively, the key 41b may be formed of another non-magnetic metal material such as aluminum or an aluminum alloy or brass, or may be formed of another non-magnetic material such as a synthetic resin material such as engineering plastic. Case 2 is the same as Case 1 in other features such as dimensions of the output shaft 41a and the key 41b.

Case 3 shown in FIG. 5C is different from Case 1 in that a plurality of through-holes 56 are formed in the magnetic key 41bm. The through-hole 56 penetrates the magnetic key 41bm along the radial direction of the output shaft 41a. Case 3 is the same as Case 1 in other features such as dimensions of the output shaft 41a and the key 41b.

Case 4 shown in FIG. 5D is different from Case 1 in that the key 41b is formed of a non-magnetic material (described as a non-magnetic key 41bn in FIG. 5D). In addition, the key 41b and the key groove for receiving the key 41b have a first length L1 (for example, 12 mm) shorter than the reference length L0 in Case 1. Case 4 is the same as Case 1 in other features.

Case 5 shown in FIG. 5E is different from Case 1 in that two magnetic keys 41bm are used. Two key grooves facing each other are formed on the output shaft 41a, and each magnetic key 41bm is fitted into a corresponding key groove. Case 5 is the same as Case 1 in other features.

Case 6 shown in FIG. 5F is different from Case 5 in that the key 41b is formed of a non-magnetic material (described as a non-magnetic key 41bn in FIG. 5F). Case 6 is the same as Case 5 in other features. Therefore, also in Case 6, the two keys 41b are used, two key grooves facing the output shaft 41a are formed, and each key 41b is fitted into the corresponding key groove.

Case 7 shown in FIG. 6A is different from Case 1 in the dimensions of the magnetic key 41bm and the key groove for receiving the magnetic key 41bm. The magnetic key 41bm has a first width W1 (for example, 3 mm) and a first height H1 (for example, 3 mm). The first width W1 is shorter than the reference width W0 in Case 1, and the first height H1 is lower than the reference height H0 in Case 1. The length of the magnetic key 41bm is the same in Case 1 and Case 7. In addition, the key groove has a first depth D1 (for example, 1.8 mm) that is shallower than the reference depth DO in Case 1. Case 7 is the same as Case 1 in other features.

Case 8 shown in FIG. 6B is different from Case 7 in that the key 41b is formed of a non-magnetic material (described as a non-magnetic key 41bn in FIG. 6B). Other features such as dimensions of the output shaft 41a and the key 41b are common to Case 8 and Case 7. Therefore, also in Case 8, the key 41b has the first width W1 and the first height H1, and the key groove has the first depth D1.

Case 9 shown in FIG. 6C is different from Case 1 in the height of the magnetic key 41bm. The magnetic key 41bm has a second height H2 (for example, 3.2 mm) lower than the reference height H0 in Case 1. Case 9 is the same as Case 1 in other features. The depth of the key groove is the same in Case 9 and Case 1, so that in Case 9, the radial protrusion height (that is, H2−D0) of the magnetic key 41bm from the output shaft 41a is smaller than the radial protrusion height (that is, H0−D0) of the magnetic key 41bm in Case 1.

Case 10 shown in FIG. 6D is different from Case 1 in that the key 41b is formed of a non-magnetic material (described as a non-magnetic key 41bn in FIG. 6D). In addition, the key groove has a second depth D2 (for example, 1.5 mm) that is shallower than the reference depth DO in Case 1. Case 10 is the same as Case 1 in other features.

Case 11 shown in FIG. 6E is different from Case 1 in that the key 41b is formed of a non-magnetic material (described as a non-magnetic key 41bn in FIG. 6E). In addition, the key groove has a third depth D3 (for example, 1.0 mm) that is shallower than the reference depth DO in Case 1. The third depth D3 is shallower than the second depth D2 in Case 10. Case 11 is the same as Case 1 in other features.

Case 12 shown in FIG. 6F is different from Case 1 in that the key 41b is formed of a non-magnetic material (described as a non-magnetic key 41bn in FIG. 6F). Further, the key groove is not formed from the tip 58 of the output shaft 41a, but is formed from the groove start position 60 closer to the base portion 59 (that is, the magnetic shield 54) than the tip 58 on the output shaft 41a toward the base portion 59 of the output shaft 41a. The lengths of the key 41b and the key groove are shorter than the reference length L0 in Case 1 by the length from the tip 58 of the output shaft 41a to the groove start position 60 (second length L2). Case 12 is the same as Case 1 in other features.

Case 13 shown in FIG. 7 is different from Case 1 in the shape of the magnetic key 41bm. The shape of the magnetic key 41bm is different between the tip 58 side and the base portion 59 side of the output shaft 41a. Specifically, the magnetic key 41bm has a lower height on the tip 58 side than the base portion 59 side, and has a step portion 61 at a position of a separation length A from the tip 58 in the axial direction of the output shaft 41a. The height H3 of the magnetic key 41bm on the tip 58 side is defined such that the radial protrusion height of the magnetic key 41bm from the output shaft 41a is substantially zero. As a result, the tip 58 of the output shaft 41a is combined with the magnetic key 41bm to have a substantially circular shape. Case 13 is the same as Case 1 in other features such as the size of the key groove.

A portion of the magnetic key 41bm on the tip 58 side is prepared as a separate part separated from the magnetic key 41bm, and may be fitted into the key groove on the tip 58 side of the output shaft 41a. The separate part is formed of a magnetic material, similar to the magnetic key 41bm.

FIG. 8 shows the standardized magnetic noise amplitude for each of Cases 1 to 13 shown in FIGS. 5A to 5F, FIGS. 6A to 6F, and FIG. 7. The standardized magnetic noise amplitude is derived by a simulation by the present inventor, and represents the ratio of the amplitude of the magnetic noise for each of Cases 2 to 13 to the amplitude of the magnetic noise for Case 1.

As can be seen from FIG. 8, in Case 2, Case 4, and Cases 8 to 13, the standardized magnetic noise amplitude is smaller than that in Case 1, which is a comparative example, that is, the magnetic noise is reduced. For example, in Case 2, Case 4, Case 9, and Case 10, the standardized magnetic noise amplitude is reduced to about 40% as compared with Case 1. Further, in Case 8, Case 11, Case 12, and Case 13, the standardized magnetic noise amplitude is reduced to about 20% as compared with Case 1. On the other hand, in Case 3, the magnetic noise is similar to that in Case 1, and in Cases 5 to 7, the magnetic noise is higher than that in Case 1.

Therefore, in order to reduce magnetic noise, it is effective that the key 41b connecting the output shaft 41a and the mating part is formed of a non-magnetic material (Case 2, Case 4, Case 8, Case 10, Case 11, and Case 12). By changing the material forming the key 41b from a magnetic material to a non-magnetic material, the magnetic saturation region that can occur at the tip of the key 41b is reduced, and therefore the magnetic noise amplitude is reduced.

In a case where the key 41b is formed of a non-magnetic material, it is also effective to reduce the magnetic noise by making the depth of the key groove relatively shallow. Specifically, for example, the depth of the key groove may be 60% or less of the width of the key groove (that is, the width of the key 41b) at the tip 58 of the output shaft 41a (Case 8, Case 10, and Case 11). In Case 8, D1/W1=0.6 (=1.8/3), in Case 10, D2/W0=0.375 (=1.5/4), and in Case 11, D3/W0=0.25 (=1/4). By making the depth of the key groove relatively shallow in this manner, rotational symmetry of the shape of the tip 58 of the output shaft 41a is improved, which can help reduce magnetic noise. In this case, the depth of the key groove is preferably 3% or more of the width of the key groove in order to ensure the key combination between the output shaft 41a and the mating part.

Among Cases where the key 41b is formed of a non-magnetic material, in Case 6, magnetic noise exceeding that in Case 1 can be generated. In Case 6, two opposite key grooves are formed on the output shaft 41a (grooves are formed at the 0 o'clock and 6 o'clock positions when viewed from the tip 58 of the output shaft 41a). A situation is considered in which an external magnetic field acts in a direction perpendicular to the center axis of the output shaft 41a. When the output shaft 41a rotates, the first rotation position where the external magnetic field is perpendicular to the two grooves and the second rotation position rotated by 90 degrees from the first rotation position are alternately repeated. The distance between the two grooves at the first rotation position is shorter than the vertical dimension of the output shaft 41a at the second rotation position (that is, the diameter of the output shaft 41a). Then, due to the magnetic resistance, the magnetic flux density acting between the two grooves due to the external magnetic field at the first rotation position becomes smaller than the magnetic flux density acting on the output shaft 41a at the second rotation position. Since such periodic fluctuations in the magnetic flux density are generated by the rotation of the output shaft 41a, it is considered that the magnetic noise becomes relatively large. Therefore, in order to reduce magnetic noise, it is suggested that the number of keys 41b provided on the output shaft 41a is preferably one instead of two.

As another countermeasure for reducing magnetic noise, a key groove for receiving the key 41b may be formed from the groove start position 60 closer to the base portion 59 (that is, the magnetic shield 54) than the tip 58 on the output shaft 41a toward the base portion 59 (the magnetic shield 54) of the output shaft 41a (Case 12, Case 13). In this manner, since the key groove is not formed at the tip 58 of the output shaft 41a, the rotational symmetry of the shape of the tip 58 of the output shaft 41a is improved. Preferably, the tip 58 of the output shaft 41a can be substantially circular. Accordingly, the magnetic saturation region at the tip 58 of the output shaft 41a can be reduced, and magnetic noise caused by the rotation can be reduced.

This countermeasure is effective not only when the key 41b is formed of a non-magnetic material (Case 12) but also when the key 41b is formed of a magnetic material. Therefore, in Case 12, the magnetic key 41bm may be used instead of the non-magnetic key 41bn. In other words, the key 41b that connects the output shaft 41a and the mating part is formed of a magnetic material, and the key groove for receiving the key 41b may be formed from the position closer to the magnetic shield 54 than the tip 58 on the output shaft 41a toward the magnetic shield 54.

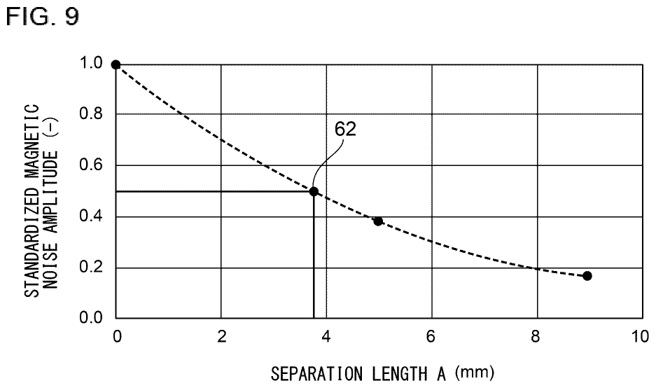

FIG. 9 is a graph showing dimensional dependence of magnetic noise according to the embodiment. FIG. 9 shows the relationship between the standardized magnetic noise amplitude and the separation length A. The separation length A corresponds to a distance from the tip 58 of the output shaft 41a to the key 41b (or the key groove) in the axial direction of the output shaft 41a. In Case 12, the separation length A represents a distance in the axial direction of the output shaft 41a from the tip 58 of the output shaft 41a to the groove start position 60. In Case 13, the separation length A represents a distance in the axial direction of the output shaft 41a from the tip 58 of the output shaft 41a to the step portion 61 of the key 41b. FIG. 9 shows the analysis results when the width of the key groove is the reference width W0 (for example, 4 mm). However, it is confirmed that the analysis results show the same tendency even when the widths of the key grooves are different values.

As shown in FIG. 9, it can be seen that the standardized magnetic noise amplitude decreases as the separation length A increases. As shown by reference numeral 62 in FIG. 9, when the separation length A is 3.9 mm (that is, when the separation length A is about the same as the key groove width W0), the standardized magnetic noise amplitude is 0.5, and can be halved as compared with Case 1. Therefore, it can be evaluated that the standardized magnetic noise amplitude is sufficiently reduced in practical use by setting the separation length A larger than the key groove width (or the width of the key 41b).

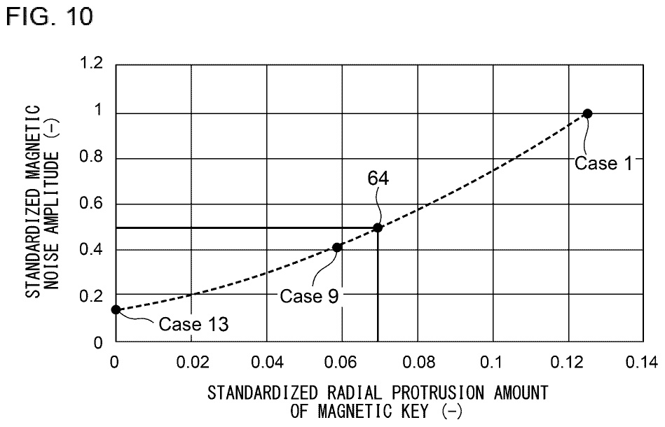

FIG. 10 is a graph showing dimensional dependence of magnetic noise according to the embodiment. FIG. 10 shows a relationship between the standardized magnetic noise amplitude and the radial protrusion height of the key 41b from the output shaft 41a. In FIG. 10, the vertical axis represents the standardized magnetic noise amplitude, and the horizontal axis represents the standardized radial protrusion height, that is, the ratio of the radial protrusion height of the key 41b to the diameter of the output shaft 41a. The radial protrusion height of the key 41b is measured at the tip 58 of the output shaft 41a.

As shown in FIG. 10, it can be seen that the standardized magnetic noise amplitude decreases as the radial protrusion height of the key 41b from the output shaft 41a decreases. In FIG. 10, Case 1, Case 9, and Case 13 as comparative examples are shown. In Case 1, the standardized radial protrusion height is about 0.125, whereas in Case 9, it is about 0.06 (that is, about 6%), and in Case 13, it is zero.

As shown by reference numeral 64 in FIG. 10, when the standardized radial protrusion height is about 0.07 (that is, about 7%), the standardized magnetic noise amplitude is 0.5, which can be halved as compared to Case 1. Therefore, it can be evaluated that the standardized magnetic noise amplitude is sufficiently reduced in practical use by setting the standardized radial protrusion height to 7% or less. In other words, the key 41b connecting the output shaft 41a and the mating part is formed of a magnetic material, the key groove for receiving the key 41b is formed on the output shaft 41a, and the radial protrusion height of the key 41b from the output shaft 41a may be 7% or less of the diameter of the output shaft 41a in the tip 58 of the output shaft 41a.

The present invention has been described above based on the examples. It will be understood by those skilled in the art that the present invention is not limited to the above embodiments, various design changes can be made, various modification examples are possible, and such modification examples are also within the scope of the present invention. Various features described in relation to the certain embodiment are also applicable to other embodiments. A new embodiment resulting from combination has the effects of each of the combined embodiments.

In the above-described embodiment, a case where the output shaft 41a of the speed reducer 41 is connected to the mating part through the key combination is described as an example. However, the output shaft 41a and the mating part may be connected by other methods such as spline connection, for example.

In the above-described embodiment, the magnetic shield 54 surrounds both the expander motor 40 and the speed reducer 41. Instead, the magnetic shield 54 may surround only the speed reducer 41. When it is evaluated that the influence of the external magnetic field on the expander motor 40 is small, or when it is evaluated that the magnetic noise generated by the expander motor 40 is small, the expander motor 40 may be disposed outside the magnetic shield 54.

The above-described embodiment has been described as an example of a case where the cryocooler 10 is a GM cryocooler, but the cryocooler according to the embodiment is not limited to the GM cryocooler. The present invention can be applied to any type of cryocooler that uses an electromagnetic motor to drive an expander, and can also be applied to other types of cryocoolers such as a Solvay cryocooler and a pulse tube cryocooler, for example.

The present invention has been described above based on the examples. It will be understood by those skilled in the art that the present invention is not limited to the above embodiments, various design changes can be made, various modification examples are possible, and such modification examples are also within the scope of the present invention.

It should be understood that the invention is not limited to the above-described embodiment, but may be modified into various forms on the basis of the spirit of the invention. Additionally, the modifications are included in the scope of the invention.

What is claimed is:

1. A cryocooler comprising:
an electromagnetic motor;
a speed reducer connected to the electromagnetic motor; and
a magnetic shield that surrounds the speed reducer.

2. The cryocooler according to claim 1, wherein
the magnetic shield surrounds the electromagnetic motor and the speed reducer.

3. The cryocooler according to claim 1, further comprising:
a mating part disposed outside the magnetic shield, wherein
the speed reducer includes an output shaft extending out of the magnetic shield and formed of a magnetic material, and
the output shaft is connected to the mating part through a key combination.

4. The cryocooler according to claim 3, wherein
a key for connecting the output shaft and the mating part is formed of a non-magnetic material.

5. The cryocooler according to claim 4, wherein
a key groove for receiving the key is formed on the output shaft from a tip of the output shaft toward the magnetic shield, and
a depth of the key groove is 60% or less of a width of the key groove at the tip of the output shaft.

6. The cryocooler according to claim 4, wherein
a key groove for receiving the key is formed on the output shaft toward the magnetic shield from a position closer to the magnetic shield than a tip of the output shaft.

7. The cryocooler according to claim 3, wherein
a key for connecting the output shaft and the mating part is formed of a magnetic material,
a key groove for receiving the key is formed on the output shaft, and
a radial protrusion height of the key from the output shaft is 7% or less of a diameter of the output shaft at a tip of the output shaft.

8. The cryocooler according to claim 3, wherein
a key for connecting the output shaft and the mating part is formed of a magnetic material, and
a key groove for receiving the key is formed on the output shaft toward the magnetic shield from a position closer to the magnetic shield than a tip of the output shaft.
